(19) United States
(12) Patent Application Publication
(10) Pub. No.: US 2001/0045342 A1
(43) Pub. Date: Nov. 29, 2001

(54) Method and device for splitting-up a stream of piece goods

(76) Inventor: Hans Frei, Oetwil am See (CH)

Correspondence Address: RANKIN, HILL, PORTER & CLARK, LLP, 700 HUNTINGTON BUILDING, 925 EUCLID AVENUE, CLEVELAND, OH, 44115-1405, US

(21) Appl. No.: 09/859,153

(22) Filed: May 16, 2001

(30) Foreign Application Priority Data
May 17, 2000 (CH) 0 986/00

(51) Int. Cl. B65G 37/00

(52) U.S. Cl. 198/358

(57) ABSTRACT

For splitting-up a supply stream (2) of piece goods into a plurality of conveying away streams, the supplied objects (3) are guided onto a plurality of conveying away paths (4.1, 4.2, 4.3) in a predetermined splitting-up sequence. A device employed for this purpose comprises a supply means for serially supplying objects (3) to a split-up point (1) and for positioning the objects (3) for being taken over by holding means (6.1, 6.2, 6.3) in the split-up point (1). The device also comprises a plurality of conveying away systems, each one of which defines one of the conveying away paths. Of the conveying away systems advantageously each one comprises a closed-in-itself rail track (5.1, 5.2, 5.3) and holding means (6.1, 6.2, 6.3) movable along the rail track independently of one another and with variable distances between one another. The rail tracks (5.1, 5.2, 5.3) of the conveying away systems converge towards the split-up point (1), run through the split-up point (1) parallel to one another and diverge after the split-up point (1). The conveying away systems further comprise means for buffering holding means (6.1, 6.2, 6.3) upstream of the split-up point (1) and means for releasing holding means from the buffers (7.1, 7.2, 7.3) in a controlled manner. Furthermore, the conveying away systems comprise means for conveying holding means (6.1, 6.2, 6.3) through the split-up point (1) in a controlled manner and means for activating the holding means in the split-up point. For the splitting-up of the objects (3) positioned in the split-up point, a serial stream of holding means through the split-up point (1) is produced by controlled release of holding means (6.1, 6.2, 6.3) from the buffers (7.1, 7.2, 7.3) of the conveying away systems. In this stream of holding means, holding means belonging to different conveying away systems are arranged in a sequence corresponding to the splitting-up sequence for the objects (3).

The invention is in the field of piece goods conveying and concerns a method and a device in accordance with the generic terms of the corresponding independent claims. The method and the device serve to split-up a stream of goods, in which a large number of identical or at least similar objects (piece goods) are serially conveyed, to form a plurality of different streams to be conveyed away. At the split-up point, the conveying path of the supply stream branches out in a plurality of conveying away paths and the objects are selectively guided onto one of the conveying away paths along which they are again serially conveyed onwards.

In the further processing of printed products, which is an example of an application for piece goods conveyance, conveyed streams can consist of printed products e.g. loosely lying on a conveyor surface (e.g., a conveyor belt). In such streams, the printed products usually overlap one another (imbricated streams). Alternatively such streams can consist of printed products being individually or in small groups held by a gripper and being conveyed behind each other, e.g., in a hanging position. The grippers used are installed on a conveying organ (e.g., a conveyor chain) or else they are movable along a rail track more or less independently of one another. Such independent grippers are driven by corresponding drives, for example, by pushing one another along.

Usually shunt-like devices are employed for splitting-up imbricated streams of printed products. Devices of this kind are located at the split-up point and comprise a conveying support being arranged between the feeder conveying support and the plurality of the conveying supports leading away. This conveying support is swivelling or otherwise movable to selectively connect the conveying support of the feeder conveyor with one or another of the conveying supports leading away. Because the printed products in the imbricated stream overlap one another, it is necessary to provide in addition to the named swivelling conveying support, means for separating the imbricated stream, i.e. for locally cancelling the overlapping of the products for every changeover of the shunt. An example of an imbricated stream shunt is described, for example, in the publication EP-1063187.

For splitting-up a stream of printed products held individually or in small groups by grippers of a supply system being installed on a conveying organ, the printed products are selectively transferred to further conveyor systems, which, for example, also have grippers installed on conveying organs and designed for guiding the printed products away along the chosen path. Transfer points to a plurality of conveying away systems are usually arranged one behind the other along the supply track and therefore use up a lot of space.

In conveying systems, in which printed products are conveyed held by grippers and in which the grippers are movable along a rail track independently of one another, points for splitting-up the conveyed stream are usually designed as rail junctions. Such points need to be equipped with control means for guiding the grippers from the supply rail to the desired rail leading away. In a conveying system comprising one or several splitting-up points of this type, provisions have to be made for the grippers, which are guided onto the various paths leading away, to be returned to a common point of departure. This means that return tracks have to be provided, which once again have to comprise shunts, resp., joining points. Conveying systems of the named kind are described, for example, in the publications WO-98/03420 and WO-98/03419, a corresponding shunt in the publication WO-99/33720.

Also known are mixed forms of the above described devices for splitting-up serial streams of piece goods.

The object of the invention is to create a method and a device, by means of which a serial stream of objects (piece goods) can be split-up into a plurality of further serial streams in which the objects are conveyed away. The splitting-up is to be controllable, for example in accordance with a predetermined split-up sequence or by conditions further downstream or upstream and recorded by sensors, or alternatively it is to be governed by a regular splitting cycle. At least the conveying away is to be a gripped conveyance, in which the objects are conveyed away individually or in small groups each held by a gripper. The device according to the invention is to be simple, as universally utilizable as possible and in particular it shall be very space-saving.

This objective is achieved by the method and by the device for splitting-up of a piece goods stream as they are defined by the claims.

According to the method defined by the invention, objects are serially conveyed towards a split-up point and at the split-up point they are positioned for being individually taken over by a holding means. For every object or small group of objects being positioned in the split-up point a holding means is supplied to the split-up point. This holding means belongs to the one conveying away system of the plurality of such systems, which defines the one leading away track on which the specific object or the specific group of objects is to be conveyed away. This means that holding means belonging to different conveying away systems are conveyed through the split-up point one after the other. For being supplied to the split-up point, the holding means are selectively released from buffers, which buffers also belong to different conveying away systems. Each one of the holding means supplied to the split-up point grips one of the positioned objects (or groups of objects) in order to convey it away from the split-up point along the leading away track of the conveying away system to which it belongs.

The objects can be supplied with a regular or irregular spacing between them. A supply stream with an essentially regular spacing can also have gaps. Depending on supply of the objects, holding means are supplied from the buffer of one conveying away system at the time to the split-up point either one per conveying cycle or selectively one or none (gap), or else just when required.

The device according to the invention comprises means for serially conveying objects to a split-up point and, at the split-up point, means for positioning the objects or groups of objects for being taken over by a holding means. The device further comprises a plurality of conveying away systems, wherein every one of the conveying away systems comprises a rail track (advantageously being closed in itself) and a plurality of holding means movable along the rail track in the direction of conveyance. The rail tracks of rails of all conveying away systems advantageously converge or run parallel towards the split-up point, run parallel to one another and as close as possible to one another through the split up point and diverge after the split-up point. As closely as possible upstream of the split-up point, every conveying away system comprises means for buffering holding means and means for a controlled release of holding means from the buffer. Every conveying away system further comprises means for controlled conveyance of holding means through the split-up point and means for activating holding means in the split-up point for picking up an object. In order to be able to be buffered and to be recalled from the buffer in a controlled manner, the holding means of every conveying away system are movable independently of one another along the rail track of the conveying away system or they are linked together with flexible means in such a manner, that the spacing between adjacent holding means is variable.

The device according to the invention further comprises control means for coordinating the recalling of the holding means from the buffer in such a manner, that the serial stream of holding means conveyed through the split-up point comprises a sequence of holding means belonging to the various conveying away systems, which sequence corresponds to a required split-up sequence.

Because for every conveying away of an object only one holding means of one of the conveying away system is released and transported through the split-up point, the holding means conveyed through the split-up point form a serial stream. In this stream the holding means can readily be conveyed on conveying paths, which are partially overlapping or identical. This means that even when the rail tracks of the conveying away systems run through the split-up point with minimum distances between each other there are no unwanted collisions during the transportation through the split-up point because of the serial release of the holding means from the various buffers. Neither is there undesirable simultaneous interaction of several holding means with a single object.

In the serial stream of holding means through the split-up point, the holding means have a spacing between one another, which is matched to the spacing between the supplied objects. This spacing can therefore be regular or irregular (also substantially regular, but with gaps).

Advantageously the rail tracks of the conveying away systems pass through the split-up point as close to one another as possible. In this manner, during the taking-over of the objects the positions of the holding means of different conveying away systems relative to the position of the objects to be taken over manifest as little difference from one another as possible. In such cases, where it is necessary for all objects to be picked up by the holding means in the same zone—independent of the path they are to be conveyed away on—, the following solution is provided: depending on which conveying away system is to take over an object, a rail track, a holding means, the object to be taken over or the supply system or a part thereof is designed to be displaceable perpendicular to the general direction of conveyance in the area of the split-up point. It is possible also to design the holding means of the various conveying away systems correspondingly differently, such that their position relative to their rail track is different.

The operating principle and some exemplary embodiments of the inventive device for splitting-up a supplied piece goods stream are described in detail on the basis of the following Figures, wherein:

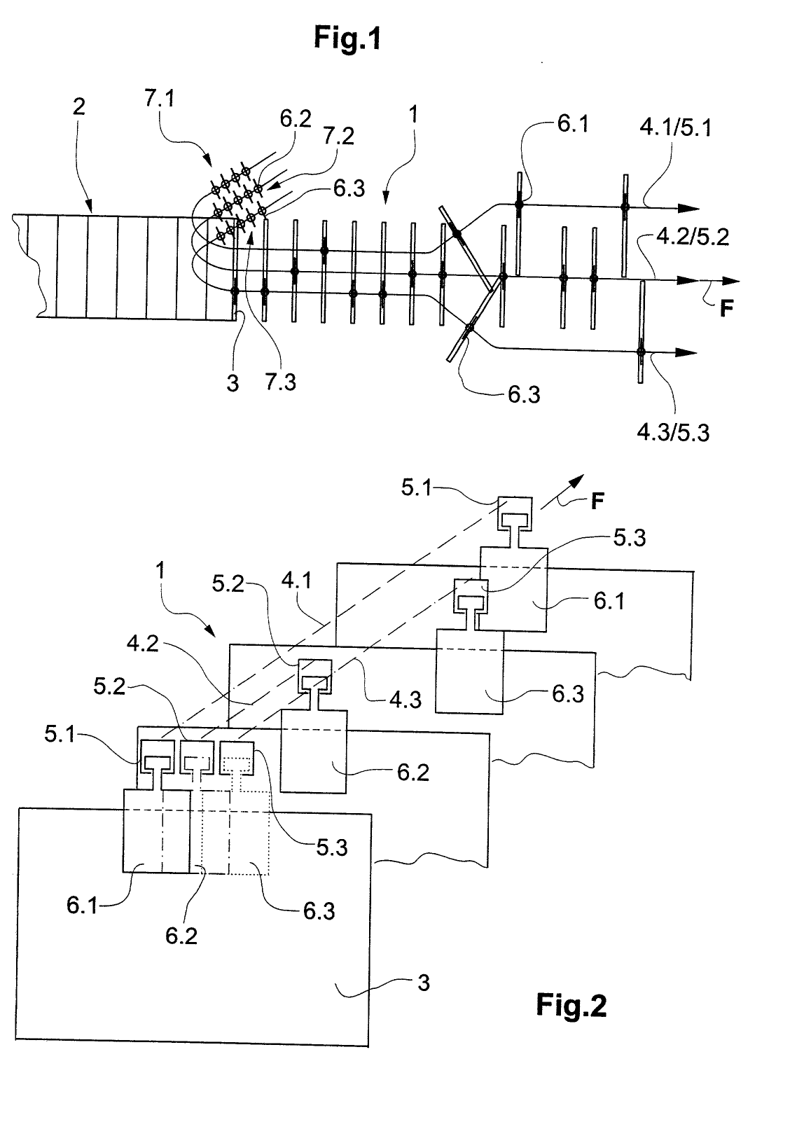

FIG. 1 shows the operating principle of the device in accordance with the invention (direction of view transverse to a general direction of conveyance F);

FIGS. 2 to 7 show some schematically illustrated, exemplary embodiments of split-up points of the device according to the invention (direction of view parallel to a general direction of conveyance F);

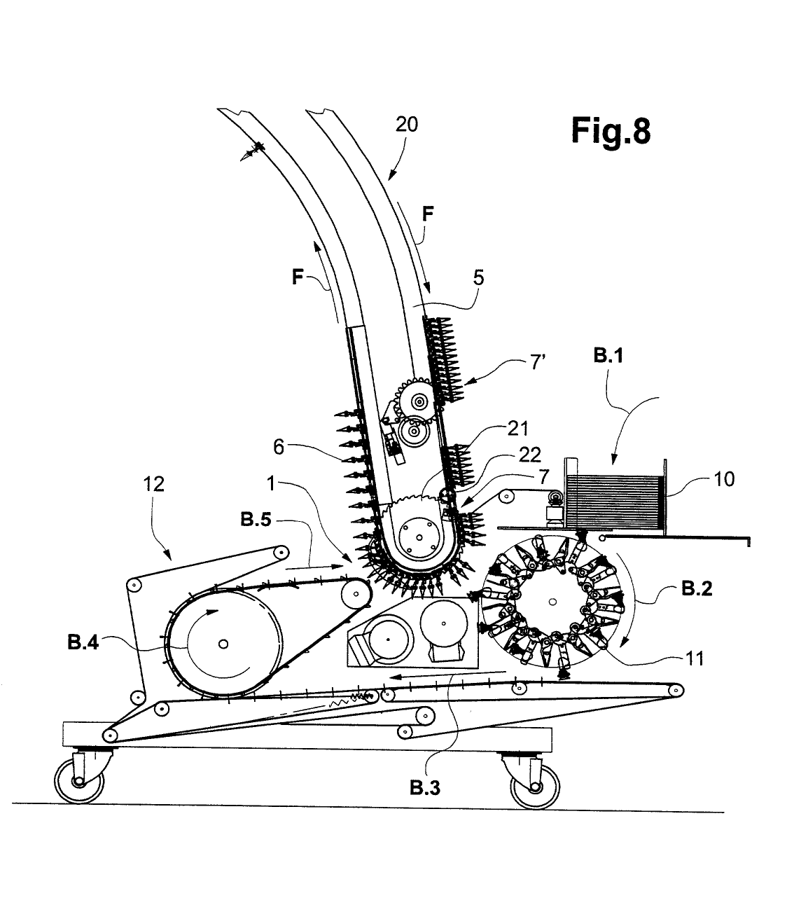

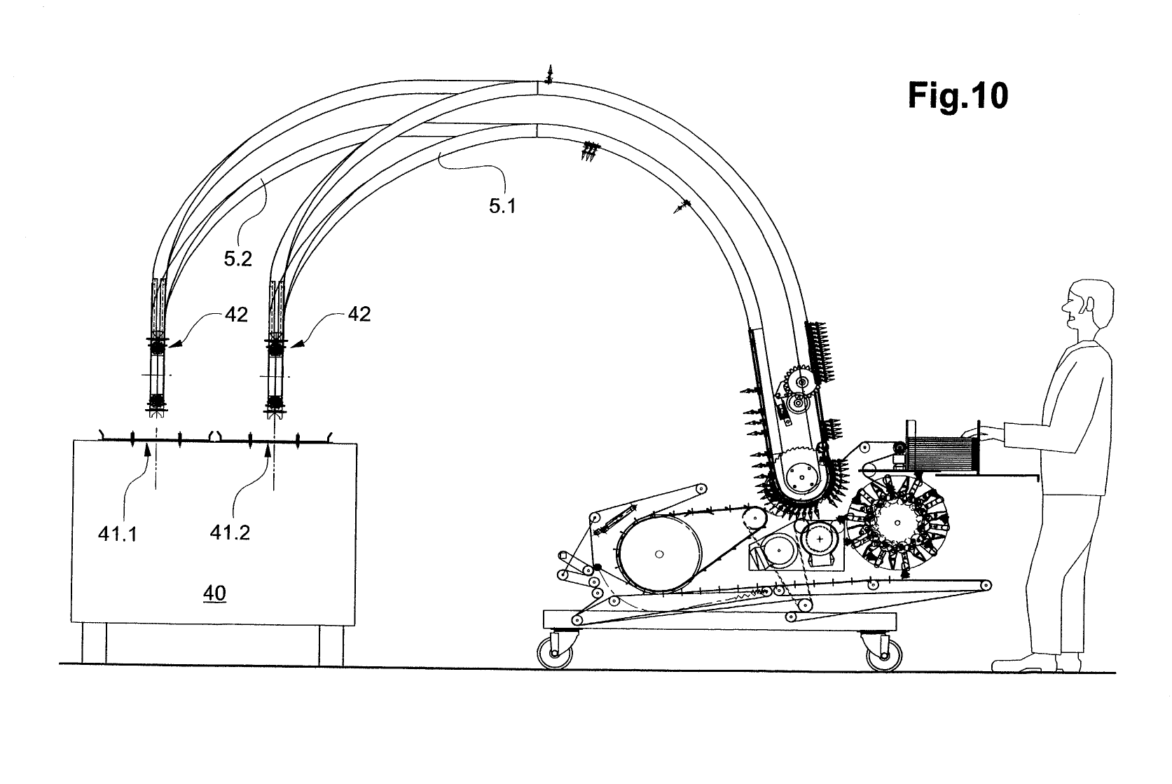

FIG. 8 shows a detailed representation of an exemplary embodiment of the device in accordance with the invention;

FIG. 9 shows a rail track with drive and holding means for a conveying away system of the device according to FIG. 8 seen in cross-section transverse to the rails;

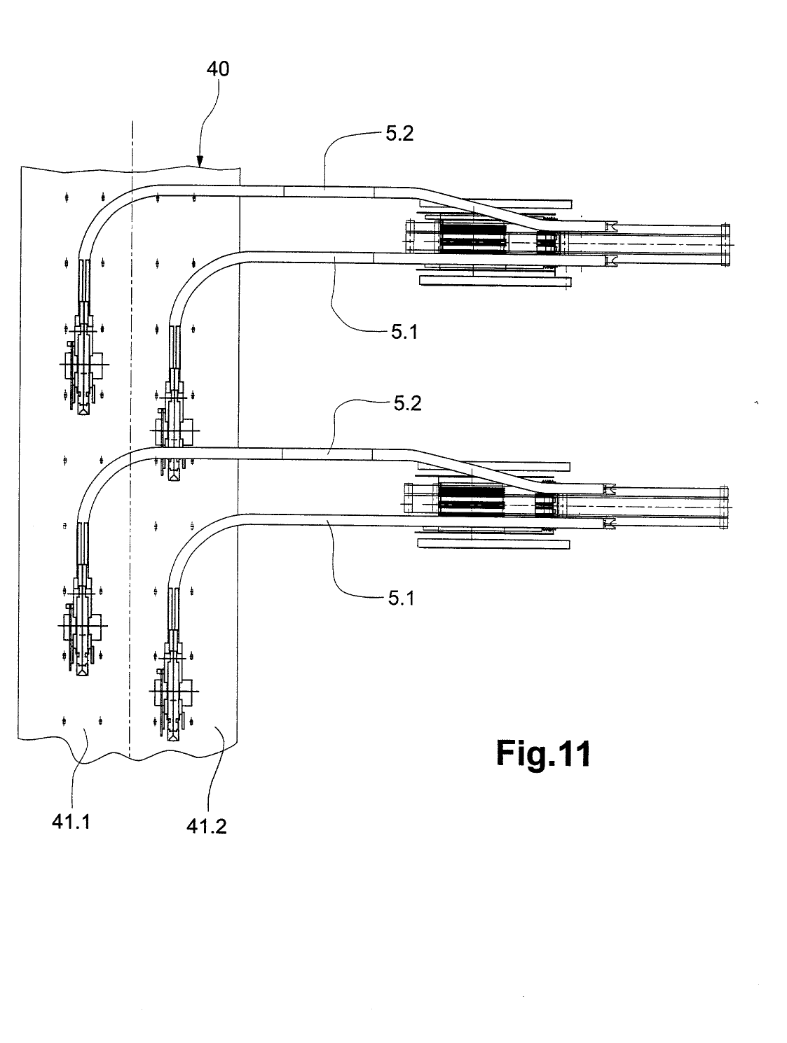

FIGS. 10 and 11 show an exemplary application of the device in accordance with FIG. 8 in side view (FIG. 10) and from a bird's eye view (FIG. 11).

FIG. 1 illustrates the operating principle of the method and the device according to the invention. Depicted is an exemplary split-up point 1 with the direction of view transverse to the conveying direction F. At the split-up point 1, a stream 2 of supplied objects 3, for example, an imbricated stream of printed product, is split-up into three conveying away paths 4.1, 4.2 or 4.3. The three conveying away paths 4.1 to 4.3 are defined by rail tracks 5.1 to 5.3, along which holding means 6.1, 6.2 and 6.3 are movable with variable distances from one another. The objects are conveyed away by the holding means, for example, in a suspended position.

The rail tracks 5.1 to 5.3 extend through the split-up point, for example, in the paper plane of FIG. 1, while the supplied objects 3 are positioned behind or underneath this plane and approach this plane coming from the left, until they can be picked up by the holding means 6.1 to 6.3 extending from the plane of the rail tracks 5.1 to 5.3 towards edge zones of the objects positioned for being picked up by the holding means.

As already mentioned further above, depending on the design of the grippers the rail tracks 5.1 to 5.3 converge towards the split-up point 1 or else they are parallel in this zone (as illustrated in FIG. 1). They pass through the split-up point 1 adjacent and parallel to one another and diverge after the split-up point 1. The depicted rail tracks 5.1 to 5.3 advantageously are parts of three closed-in-themselves rail tracks, of which each one belongs to one of the three conveying away systems.

Upstream of the split-up point 1, the holding means 6.1, 6.2 and 6.3 are buffered on each of the rail tracks 5.1, 5.2 and 5.3. They are released from buffering in accordance with the splitting-up sequence and are driven through the split-up point 1 in a serial stream of holding means, within which consecutive holding means 6.1, 6.2 or 6.3 can belong to different conveying away streams and are therefore conveyed along different rail tracks 5.1, 5.2 or 5.3. Conveyance of holding means 6.1, 6.2 or 6.3 through the split-up point 1 leads these towards the supplied objects 3 in such a way, that objects 3 are picked up by activating holding means and are conveyed away in a held manner.

From FIG. 1 it is also evident, that when using holding means 6.1, 6.2 and 6.3 of the same design for all conveying away systems, the objects 3 are picked up in different holding zones by holding means of different conveying away systems. According to FIG. 1, the holding means 6.2 being movable along the middle rail track 5.2 grips an object in the middle of its edge. Holding means 6.1 and 6.3 of the other two rail tracks 5.1 and 5.3 grip the objects in a holding zone off this middle.

This is even more apparent from FIG. 2, which shows the arrangement in accordance with FIG. 1 in a schematic 3D-view with the direction of view essentially parallel to the conveying paths 4.1 to 4.3 running through the split-up point 1 (indicated as dot-and-dash lines).

Shown right at the front are the three rail tracks 5.1 to 5.3 in cross-section transverse to the direction of conveyance F, with corresponding holding means 6.1 (unbroken line), 6.2 (dot-and-dash line) and 6.3 (dotted line). For showing the different holding zones on an object 3 to be picked up or already picked up, the holding means 6.1, 6.2 and 6.3 are illustrated in front in interaction with a single object 3. Such simultaneous interaction is of course not possible in the serial stream of holding means being conveyed through the split-up point.

Shown in the direction of conveyance further downstream are a further three objects 3, the first one of which is conveyed held by a holding means 6.2 movable along the rail track 5.2, the second one by a holding means 5.3 movable along the rail track 5.3 and the third one by a holding means 6.1 movable along the rail track 5.1. An arrangement of holding means and objects of this kind is possible in reality. It represents the serial stream of holding means, in which every holding means 6.1, 6.2 or 6.3 conveyed one behind the other can each be movable along a different rail track 5.1, 5.2 or 5.3.

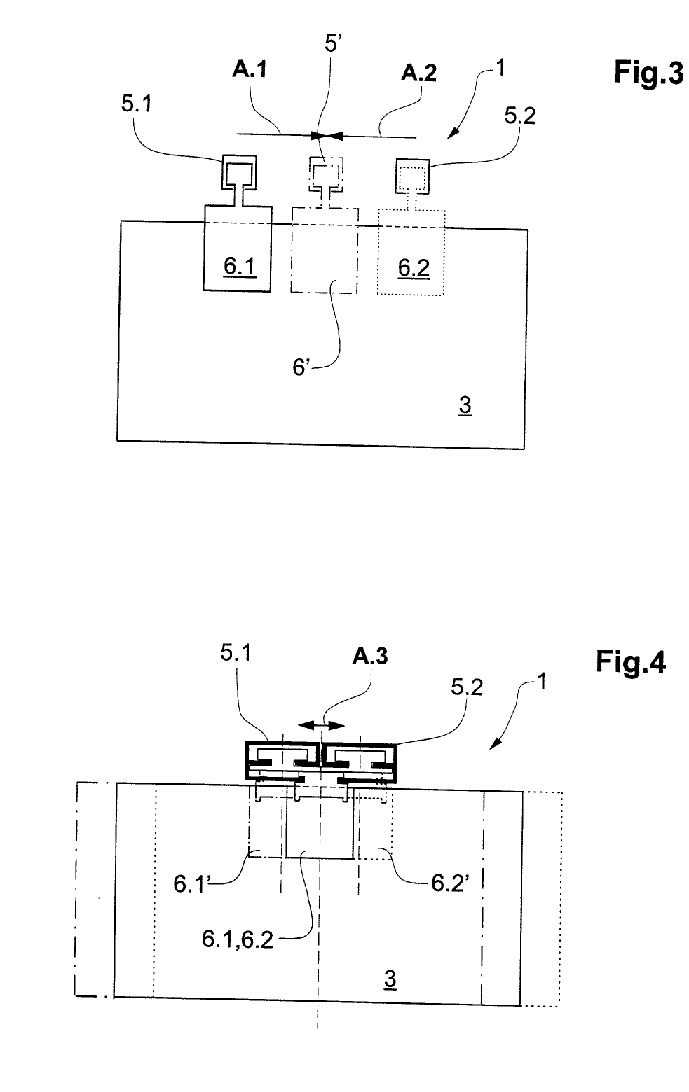

Various measures can be implemented to ensure that the objects being held by holding means movable along different rail tracks are not picked up and held in different holding zones as depicted in the FIGS. 1 and 2. Examples of such measures are illustrated by FIGS. 3 to 7. In these Figures, split-up points 1 with a plurality of rail tracks and holding means are depicted with a viewing direction parallel to the conveying direction. In these Figures, same parts are designated with same reference numbers as in the FIGS. 1 and 2.

FIG. 3 depicts a split-up point 1 with two parallel rail tracks 5.1 and 5.2, along which holding means 6.1 (unbroken line) and 6.2 (dotted line) are movable. In order for positioned objects 3 to be picked up in a predetermined, for example, central holding zone, both by the holding means 6.1 as well as by the holding means 6.2, the one rail track (5.1 or 5.2) carrying the holding means designated for the picking-up, is moved transverse to the conveying direction into a position 5′ (dot-and-dash line) (arrows A.1 and A.2). From this rail track position a holding means 6′ movable along the displaced rail track can pick up the object 3 in the predetermined holding zone.

FIG. 4 illustrates a split-up point 1 with a pair of rail tracks 5.1 and 5.2 running parallel and adjacent to one another and holding means 6.1 and 6.2 being couplable to two magnetic slip-drives as described in the publication WO-99/33731 (FIGS. 9a to 9c). In the split-up point, the two rail tracks run together and the grippers are brought to an identical middle position (represented as an unbroken line) (arrow A.3), independent to which rail track they are belonging to, and they pick-up the objects 3 in the middle. After the split-up point, the rail tracks diverge (positions 6.1′ and 6.2′ of the holding means).

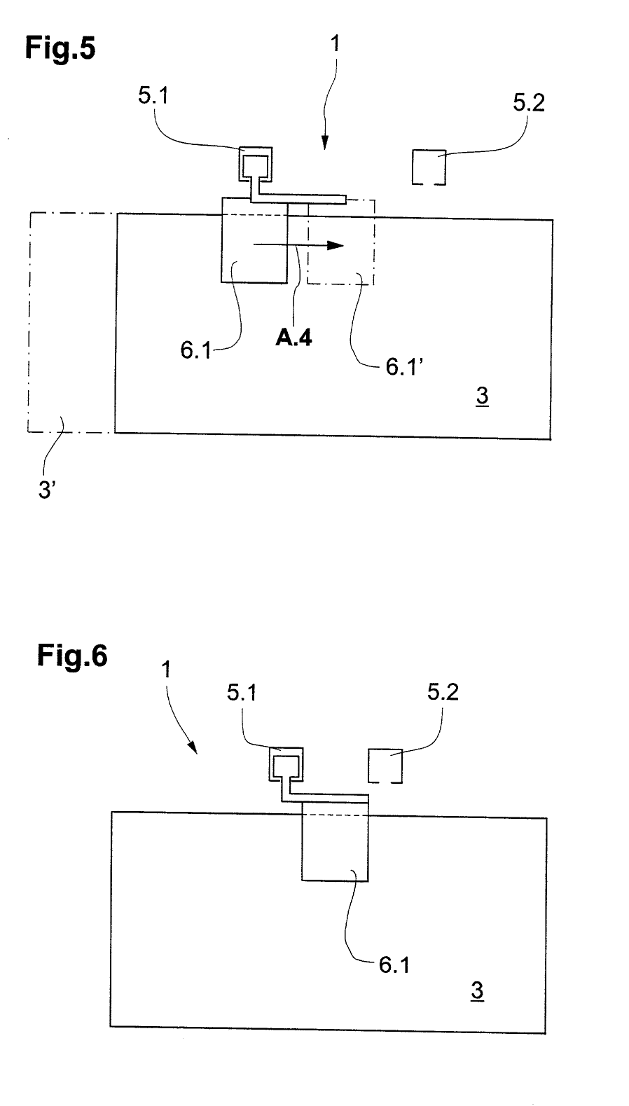

FIG. 5 depicts a split-up point 1, once again with two rail tracks 5.1 and 5.2 running parallel to one another. Holding means (only 6.1 shown) movable along the rail tracks are displaceable relative to the rail track transverse to the conveying direction (arrow A.4 to position 6.1′, which is represented with a dot-and-dash line), such that the holding means of both rail tracks, when displaced, are able to pick-up a positioned object 3 in the same, predetermined holding zone (for example, in the middle). After picking up, the holding means can be moved back again (position 6.1) for conveying the object (3′ represented with a dot-and-dash line) away.

FIG. 6 depicts a split-up point 1, once again with two rail tracks 5.1 and 5.2 running parallel to one another. The holding means (only one holding means 6.1 is shown) are designed in such a way, that they are conveyed on a conveying path, which is offset relative to the rail track. Using holding means on tracks 5.1 and 5.2 being offset in opposite directions, it becomes possible to transport the holding means of both rail tracks on the same conveying path and, independent of the rail track they are to be conveyed away on, to pick up the objects 3 in the same holding zone without the necessity of an active displacement of the object or any other parts.

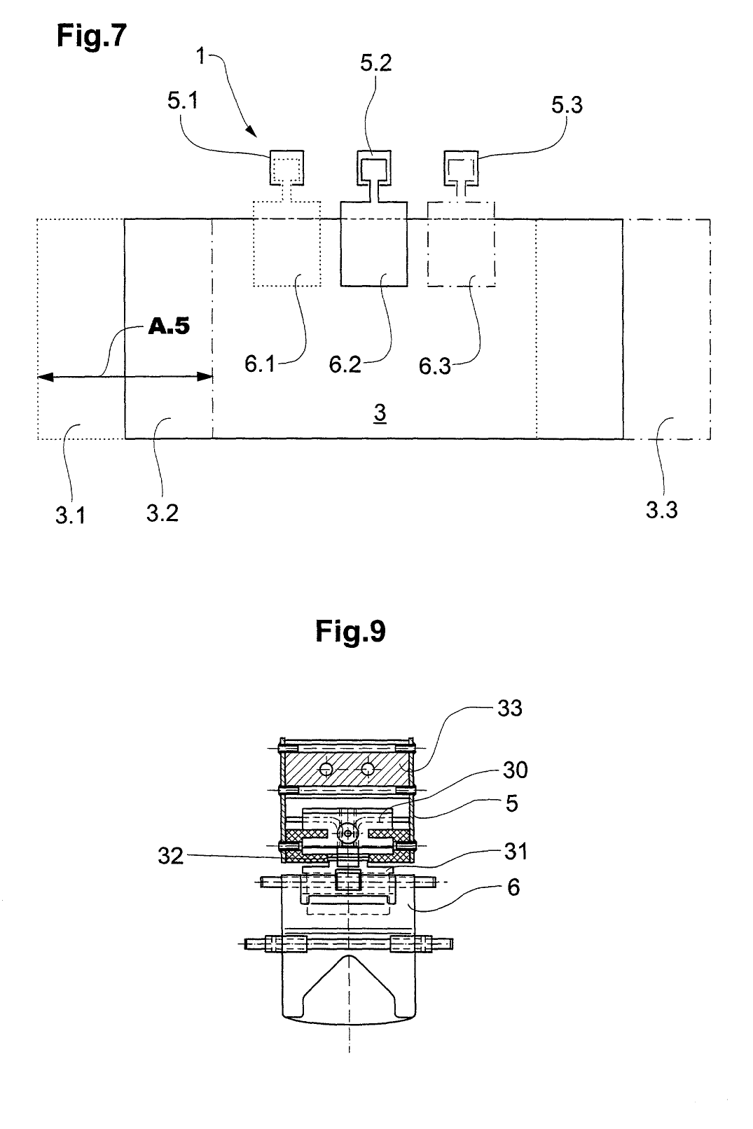

FIG. 7 illustrates a split-up point with three rail tracks 5.1, 5.2 and 5.3 running parallel to one another and with corresponding holding means 6.1 (dotted line), 6.2 (unbroken line) and 6.3 (dot-and-dash line). For a central picking up of objects 3 positioned at the split-up point, the objects are displaced transverse to the conveying direction into a corresponding pick-up position 3.1 (dotted line), 3.2 (unbroken line) or 3.3 (dot-and-dash line) (arrows A.5). For displacing the objects 3, either only individual objects, the whole conveying means or parts thereof are displaced transverse to the conveying direction.

FIG. 8 depicts an exemplary embodiment of the device in accordance with the invention for splitting up a stream of printed products into a plurality of conveying away streams, wherein only one of the conveying away systems is visible.

The supply means for conveying the objects in a serial stream to the split-up point 1 and for positioning the objects in the split-up point, comprises for the illustrated device in per se known manner, a stacking device 10, a decollating wheel 11 and a conveying means 12 for conveying an imbricated stream or sections of an imbricated stream. The stacking device 10 serves to receive stacked printed products, which, for example, are filled into the stacking device 10 by hand (arrow B.1). With the help of the decollating wheel 11, the printed products are decollated from the stacking device 10 and are deposited on the conveying means 12 in an imbricated formation (arrow B.2). With the help of the conveying means, the imbricated formation is conveyed to the split-up point 1 (arrows B.3, B.4 and B.5).

Instead of the supply system as shown in FIG. 8 which functions like a sheet feeder feeding from a stack, the printed products can also be supplied from other storing formations, for example, from a coil by means of an uncoiling station, wherein from the coil an imbricated stream of printed products is uncoiled and conveyed to the split-up point 1.

The conveying away systems 20, of which only one is visible and of which the others are located behind this one, comprise a closed-in-itself rail track 5, along which holding means 6 in the form of grippers are movable in a conveying direction F with variable distances between one another. The holding means 6 are conveyed through the split-up point 1 by a drive wheel 21. All conveying away systems 20 comprise an identical drive wheel 21 and all drive wheels are arranged coaxially with shafts transverse to the conveying direction F and as closely adjacent to one another as possible. Upstream of each drive wheel 21 there is a buffer 7 for the holding means (for empty holding means), i.e., a holding means stop 22, behind which the holding means pile up driven either by the force of gravity or by a slip-drive. This holding means stop 22 is appropriately controlled for the purpose of releasing one holding means 6 at a time to the drive wheel 21. For the purpose of relieving the holding means stop 22, a pre-buffer 7′ may be located upstream of the holding means buffer 7.

Downstream of the split-up point 1, i.e., after the picking up of a printed product, the holding means 6 are conveyed away, for example, by the same slip-drive as used for the buffering upstream of the drive wheel 21.

Obviously it is possible to use in a device for splitting-up a stream of piece goods more than one supply means, being selectively connected to the split-up point and therewith to the plurality of conveying away systems by means of a corresponding shunt.

FIG. 9 depicts a rail track 5 with a magnetic slip-drive in cross-section and a holding means 6 movable along the rail track 5. The illustrated rail track 5 and the holding means 6 are applicable in a conveying away system of a device in accordance with FIG. 8. The holding means 6 comprises a sliding block 31, which at least in the vicinity of a coupling surface 32 partially consists of a ferro-magnetic material. The sliding block 31 comprises two lateral grooves, into which the rail track 5 engages. The slip-drive comprises drive elements 30 consisting of a ferromagnetic material and being driven along the stretch of rails 5 by a suitable drive. The drive elements 30 also have two lateral grooves, into which the rail track 5 engages. In zones of the rail track 5, in which the holding means 6 are to be actively conveyed, permanent magnets 33 and magnetic conductance guiding organs are located in the vicinity of the rail track. These together with the ferro-magnetic parts of the drive elements 30 and the ferro-magnetic parts of the sliding blocks 31 of the holding means form a magnetic circle, through which the sliding block 31 is pulled towards the drive elements 30 by magnetic forces, adheres to these and together with these is moved in the conveying direction.

When the holding means 6 are stopped by a suitable stop, the moving drive elements 30 slide relative to the sliding blocks 31 of the stopped holding means 6, which is suitable for the buffering of holding means 6 on not sloping down zones of the rail track 5. On zones sloping down, the force of gravity can be exploited for the buffering of the holding means 6.

Conveyor systems as illustrated in FIG. 8 as conveying away systems and in FIG. 9 as a detail, are described in the publications WO-99/33731. Further conveying devices suitable as conveying away system in a device in accordance with the invention are described in the publication EP-633212. In these devices, the holding means are connected together with spring-like links to form a chain with variable distances between holding means.

FIGS. 10 and 11 illustrate an exemplary application of a device according to the invention, as is depicted, for example, in FIG. 8 (FIG. 10: side view; FIG. 11: bird's eye view). The device comprises at least two conveying away devices, each with a closed-in-itself rail track 5.1 and 5.2. It serves for feeding part products to a collating device 40, in which on two or more than two collating stretches 41.1 and 41.2 running essentially parallel to one another, similar or identical products are produced by collation of part products. At feed points, at which identical part products are fed to both collating stretches, advantageously a device as depicted in FIGS. 10 and 11 is utilized. The conveying away systems of the device advantageously also comprise a holding means buffer 42 on the delivery side immediately ahead of the point, at which the part products are delivered to the collating stretch. In this application, the device in accordance with the invention is essentially used for alternatingly filling the two holding means buffers 42 of the two conveying away systems.

For a device as illustrated in FIGS. 10 and 11, it is in no way a prerequisite, that the two collating devices are operated with the same performance capacity or that both collating devices are active. The performance capacities of the collating devices are completely de-coupled from one another. The supply capacity has to be adapted to the overall consumption by the collating averaged over time. Thanks to the buffering of the products to be fed in, however, the supply capacity is to a great extent decoupled from the performance capacities of the collating devices.

In a similar manner as depicted in FIGS. 10 and 11, the device in accordance with the invention can also be utilized for supplying products to other processing stations, which are in essence operated in parallel.

1. Method for splitting-up according to a predetermined splitting-up sequence a serial stream (2) of objects to be conveyed away along a plurality of conveying away paths, the method comprising the steps of:
serially supplying a large number of objects (3) to a split-up point (1) and positioning each object in the split-up point (1),
providing holding means (6.1, 6.2, 6.3) to be conveyed in a serial holding means stream through the split-up point (1) each holding means (6.1, 6.2, 6.3) being assigned fixedly to one of the conveying away paths,
at the split-up point, taking over each positioned object by one of the holding means (6),
and serially conveying away the objects (3) from the split-up point, each object being held by a holding means (6),
wherein the sequence of the holding means (6.1, 6.2, 6.3) assigned to different conveying away paths in the serial holding means steam conveyed through the splitting-up point corresponds to the splitting-up sequence.

2. Method in accordance with claim 1 wherein the splitting-up sequence is predetermined from outside or is adapted to conditions upstream or downstream of the split-up point (1) which conditions are recorded by sensor means.

3. Method in accordance with claim 1, wherein for establishing the serial stream of holding means, the holding means (6.1, 6.2, 6.3) assigned to different conveying away paths are released from a plurality of holding means buffers (7.1, 7.2, 7.3) which are also assigned to the different conveying away paths.

4. Method in accordance with claim 1, wherein the holding means (6.1, 6.2, 6.3) assigned to the different conveying away paths are conveyed through the split-up point (1) on different conveying paths, which are parallel to one another.

5. Method according to claim 4, wherein the objects (3) positioned in the split-up point (1) for being taken over by a holding means (6.1, 6.2, 6.3), are taken over in different holding zones by holding means (6.1, 6.2, 6.3) assigned to different conveying away paths.

6. Method in accordance with claim 4, wherein for taking over the objects (3) positioned in the split-up point (1) in the same holding zone by holding means (6.1, 6.2, 6.3) assigned to different conveying away paths, the conveying paths are displaced.

7. Method in accordance with claim 4, wherein for taking over the objects (3) positioned in the split-up point (1) in the same holding zone by the holding means (6.1, 6.2, 6.3) assigned to different conveying away paths, the holding means are displaced transverse to the conveying paths.

8. Method according to claim 4, wherein for taking over the objects (3) positioned in the split-up point (1) in the same holding zone by the holding means (6.1, 6.2, 6.3) assigned to different conveying away paths, the holding means (6.1, 6.2, 6.3) assigned to different conveying away paths differ in design.

9. Method according to claim 4, wherein the objects (3) are positioned differently in the split-up point (1) to such an extent, that they are picked up in the same holding zone by holding means (6.1, 6.2, 6.3) assigned to different conveying away paths.

10. Device for splitting-up a serial stream (2) of objects (3) according to a predetermined splitting-up sequence to be conveyed away along a plurality of conveying away paths, the device comprising
a supply device (10, 11, 12) for serially supplying and for positioning the objects (3) in a split-up point (1)
assigned to each conveying away path a conveying away system for conveying away the objects (3) from the split-up point (1) in a held manner, each one of the conveying away systems comprising a rail track (5.1, 5.2, 5.3) and holding means (6.1, 6.2, 6.3) movable in a conveying direction (F) along the rail track (5.1, 5.2, 5.3) with variable distances between one another,
wherein the rail tracks (5.1, 5.2, 5.3) of all conveying away systems run through the split-up point (1) in a direction of conveyance (F) and parallel to one another and diverge downstream of the split-up point (1),
wherein every one of the conveying away systems further comprises means for buffering the holding means (6.1, 6.2, 6.3) upstream of the split-up point (1) and for releasing the holding means (6.1, 6.2, 6.3) from the buffers (7.1, 7.2, 7.3) in a controlled manner and means (21) for conveying the holding means (6.1, 6.2, 6.3) through the split-up point (1) in a controlled manner, and
wherein the device further comprises means for coordinating the release of holding means from the buffers (7.1, 7.2, 7.3) in accordance with the splitting-up sequence.

11. Device in accordance with claim 10, wherein the holding means (6.1, 6.2, 6.3) are movable along the rail tracks (5.1, 5.2, 5.3) independently of one another or connected together with flexible links in such a manner, that the distances between the holding means (6.1, 6.2, 6.3) are variable.

12. Device according to claim 10, wherein the means for controlled conveyance of the holding means (6.1, 6.2, 6.3) through the split-up point (1) is a drive wheel (21).

13. Device in accordance with claim 12, wherein the drive wheels (21) of the conveying away systems are arranged coaxially.

14. Device in accordance with claim 10, wherein the rail tracks (5.1, 5.2, 5.3) of the conveying away systems running through the split-up point (1) are displaceable transverse to the conveying direction (F) in such a way, that the holding means (6.1, 6.2, 6.3) of every conveying away system at the split-up point (1) are capable of being brought into a same predetermined position relative to the objects (3) positioned at the split-up point (1).

15. Device according to claim 10, wherein at least at the split-up point (1), the holding means (6.1, 6.2, 6.3) are displaceable transverse to the conveying direction (F) relative to the rail track (5.1, 5.2, 5.3), along which they are movable, in such a manner, that the holding means (6.1, 6.2, 6.3) of every conveying away system are capable of being brought into a same predetermined position relative to the objects (3) positioned at the split-up point (1).

16. Device in accordance with claim 10, wherein the holding means (6.1, 6.2, 6.3) of the different conveying away systems are designed in such a different manner, that the holding means (6.1, 6.2, 6.3) of each conveying away system are capable of being brought into a same predetermined position relative to the objects (3) positioned at the split-up point (1)

17. Device according to claim 10, wherein the supply means (10, 11, 12) for serially supplying and positioning the objects (3) in the split-up point (1) or parts of this means (10, 11, 12) are displaceable transverse to the direction of conveyance (F) in such a way, that the holding means (6.1, 6.2, 6.3) of each conveying away system at the split-up point (1) are capable of being brought into a same predetermined position relative to the objects (3) positioned at the split-up point (1).

18. Device according to claim 10, wherein the supply device (10, 11, 12) for serially supplying and positioning the objects (3) in the split-up point (1) comprises a stacking device (10), a decollating wheel (11) and a conveying means (12) for conveying an imbricated stream of objects.

19. Device in accordance with claim 10, wherein the supply device (10, 11, 12) for serially supplying and positioning the objects (3) in the split-up point (1) comprises an uncoiling station for uncoiling a coil of printed products.

20. Device according to claim 10, wherein a plurality of supply devices (10, 11, 12) being selectively connectable to the split-up point (1) is provided.

21. Use of a device in accordance with one of claims 10 to 20 for supplying printed products to a plurality of processing stations operating in parallel.

22. Use of a device according to one of the claims 10 to 20 for supplying printed products to a plurality of devices (41.1, 41.2) for collating printed products, which devices are operating in parallel.
